(19) United States
(12) Patent Application Publication
(10) Pub. No.: US 2017/0328551 A1
(43) Pub. Date: Nov. 16, 2017

(54) LASER SPOT LIGHT WITH IMPROVED RADIATING STRUCTURE

(71) Applicant: Jun Xi, Dongguan (CN)

(72) Inventor: Jun Xi, Dongguan (CN)

(21) Appl. No.: 15/406,849

(22) Filed: Jan. 16, 2017

Related U.S. Application Data
(63) Continuation-in-part of application No. 15/203,983, filed on Jul. 7, 2016, now Pat. No. 9,655,209.
Application No. 15/203,983 is a continuation-in-part of application No. 15/236,439, filed on Aug. 14, 2016.

(30) Foreign Application Priority Data
May 12, 2016 (CN) 201620436630.8

(51) Int. Cl. F21V 29/70; F21V 14/08; F21V 11/08; F21Y 2115/30; F21Y 2113/10

(52) U.S. Cl. CPC F21V 29/70; F21V 14/08; F21V 11/08; F21Y 2113/10; F21Y 2115/30

(57) ABSTRACT

The present invention provides a laser spot light with improved radiating structure which includes a cylindrical shell, a mounting board fixed within the cylindrical shell, at least one laser head, an inner radiator made from heat-conductive metal and configured for supporting the at least one laser head and fixed on the mounting board, and an outer radiator made from heat-conductive metal and fixed to the side wall of the cylindrical shell with a part of the outer radiator passing across the cylindrical shell and touching with the inner radiator. Therefore an inner heat can be conducted to the outside of the cylindrical shell, and an operation temperature of the laser head can be maintained in a normal range.

### CROSS-REFERENCE TO RELATED APPLICATIONS

The present application is a continuation-in-part of U.S. patent application Ser. No. 15/203,983, filed Jul. 7, 2016, which claims the benefit of CN Patent Application No. 201610207559.0, filed Apr. 1, 2016, and U.S. patent application Ser. No. 15/236,439, filed Aug. 14, 2016, which claims the benefit of CN Utility Patent Application No. 201620744193.6, filed Jul. 12, 2016, all of which are incorporated herein by reference in their entireties. The present application also claims the benefit of CN Patent Application No. 201620436630.8, filed May 12, 2016.

### BACKGROUND OF THE INVENTION

### 1. Field of the Invention

The present invention relates to outdoor illumination devices, and more particularly to a laser spot light with improved radiating structure.

### 2. Description of Related Art

Laser spot lights are commonly classified into laser spot lights with fixed/static raster images and cartoon laser spot lights utilizing motor dirving. Typically, a laser spot light uses one or two laser head to generates colorful light spots. An operating ambient temperature range of a laser head is 10-35 degrees centigrade, thus the radiating structure of the laser spot light is very important in mantaining normal operations of the laser head. Traditional laser spot lights use a forced air cooling radiator or a liquid cooling radiator to dissipate heat generated of the laser head. However, structures of these radiators are complicated and with large bulk.

Therefore, there is a need for a laser spot light with improved radiating structure.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is an exploded view of a laser spot light with improved radiating structure in accordance with an embodiment of the present invention.

FIG. 2 is a partial cut-away view of the laser spot light.

FIG. 3 is an exploded view of a laser spot light with improved radiating structure in accordance with another embodiment of the present invention.

### DETAILED DESCRIPTION OF THE INVENTION

The invention will now be described in detail through several embodiments with reference to the accompanying drawings.

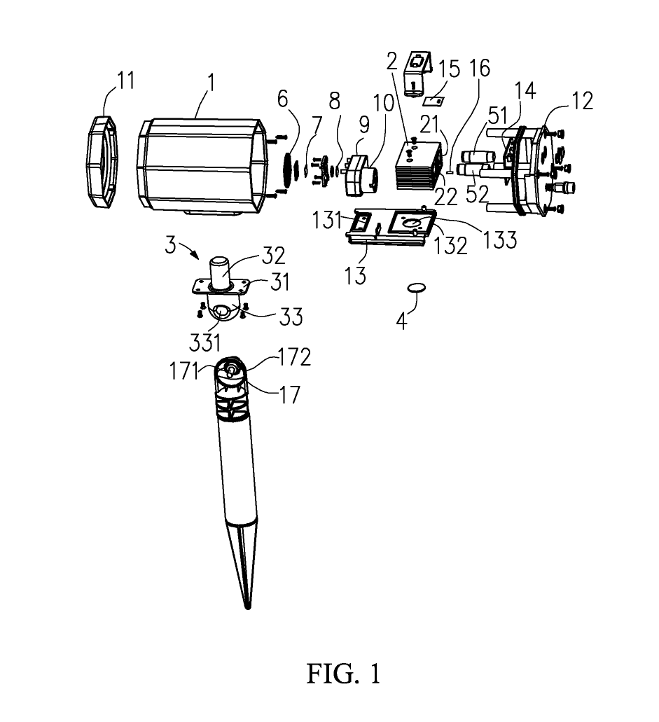

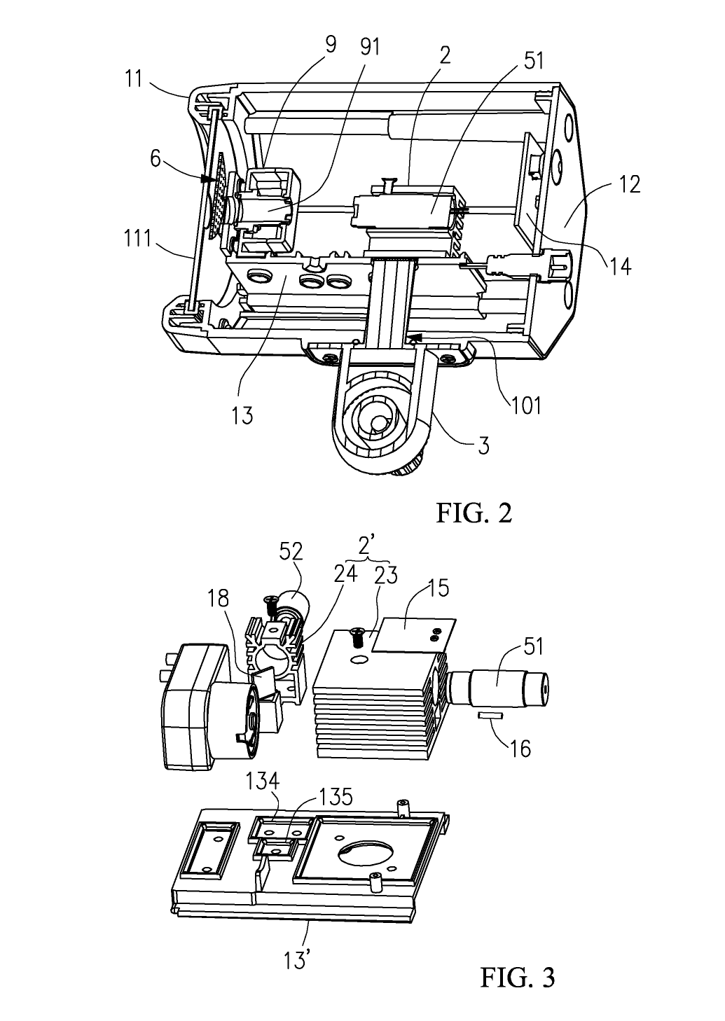

Please refer to FIG. 1 to FIG. 2, a laser spot light with improved radiating structure in accordance with an embodiment of the present invention includes a cylindrical shell 1 maily housing an inner radiator 2, two laser heads 51, 52, a light baffle 6, a first grating 7, a second grating 8, a gearbox 9, a motor 10, a mounting board 13 and a circuit board 14. The laser spot light further includes an outer radiator 3 connected to the cylindrical shell 1 and contacting with the inner radiator 2. In FIG. 2, a part of the cylindrical shell 1, the inner radiator 2, the outer radiator 3, the laser heads 51, 521, the light baffle 6, the first grating 7, the second grating 8, the gearbox 9, the mounting board 13 and the circuit board 14 is cut away, and the motor 10 is not shown.

The cylindrical shell 1 is substantially a hollow cylinder. An end surface of the cylinder defines a first opening covered with a front cover 11, and the opposite end surface of the cylindrical shell 1 defines a second opening covered with a rear cover 12. The front cover 11 defines a light transmission window, a glass 111 is mounted in the light transmission window to permit light emitting out of the cylindrical shell 1. The cylindrical shell 1 also defines a first through hole 101 in its side wall.

The mounting board 13 is substantially a plate made from plastic materials and is fixed to the inner wall of the cylindrical shell 1. Plural of walls extend upwardly from the mounting board 13 to form two square frames 131, 132 used for receiving the lower parts of the gearbox 9 and the inner radiator 2, respectively. A second through hole 133 is defined in a central part of the square frame 132 which correspindes to the first through hole 101 in the side wall of the cylindrical shell 1.

The inner radiator 2 is fixed on the mounting board 13 and located within the square frame 132. The inner radiator 2 is made from heat-conductive metal, aluminium alloy for example, and includes plural of heat fins. The inner radiator 2 defines two sockets or two grooves 21 used for receiving two laser heads 51, 51, respectively. Such that the laser heads 51, 52 are fixed and supported by the inner radiator 2, and the heat generated by the laser heads 51, 52 is dissipated by the inner radiator 2 to prevent overheat.

The outer radiator 3 is also made from heat-conductive metal, it is connected to the side wall of the cylindrical shell 1 from outside, a part of the outer radiator 3 passes through the first through hole 101 and the second through hole 133 and touches with the inner radiator 2 so as to conduct heat out of the cylindrical shell 1. For better thermal contact effect, a layer of heat-conducting adhesive 4 is set between the inner radiator 1 and the outer radiator 3.

In the embodiment, the outer radiator 3 includes a plate 31 mounted to the side wall of the cylindrical shell 1 from the outside of the cylindrical shell 1, a post 32 extending perpendicularly from an inner side (facing the cylindrical shell 1) of the plate 31 and passing through the first through hole 101 and then the second through hole 133 to touch with the inner radiator 2 via the layer of the heat-conducting adhesive 4, and a protruding part extending perpendicully from an outer side of the plate 31. Depending on the outer radiator 3, the inner heat of the laser spot light can be conducted to the outside of the spot light, therefore having good heat dissipation effect.

The laser spot light further includes a heating element 15 and a temperature sensor 16 attached to/mounted in the inner radiator 2. In the embodiment, a through hole 22 is defined in the inner radiator 2, the temperature sensor 16 is inserted in the through hole 22. The heating element 15 is attated to an upper surface of the inner radiator 2.

The laser heads 51, 52, the temperature sensor 16, and the heating element 15 are electrically connected to and controlled by the circuit board 14. When the circuit board 14 determines that an operation temperature of the laser heads 51, 52 are higher than or equal to a preset highest value based on an output of the temperature sensor 16, a power supplied to the laser heads 51, 52 may be reduced, and/or a power supplied to the motor 10 is reduced or cut off. When the circuit board 14 determines that an operation temperature of the laser heads 51, 52 are lower than or equal to a preset lowest value based on an output of the temperature sensor 16, the heating element 15 is electrified to heat the inner radiator 2, such that the operation temperature of the laser heads 51, 52 is maintained in a normal range.

The laser heads 51, 52 may be a green laser head having a green laser emitter capable of emitting green laser beams and a red and blue double tunnel laser head having a green laser emitter and a blue laser emitter. The laser heads may also have other laser emitters which can emitter laser beams in other colors.

The light baffle 6, the first grating 7, and the second grating 8 are sequentially set between the front cover 11 and the laser heads 51, 52. The second grating 8 has a pattern of figures, such as an angel image, and is fixedly set close to the the laser head. The second grating 8 separates the laser beam/beams outputted by the laser heads 51, 52 into several beams and the several beams form a figure/imagery corresponding to the pattern of figure of the second grating 8, like an angel imagery. The first grating 7 has a star pattern and is fixedly set between the light baffle 6 and the second grating 8. The laser beams emitted from the second grating 8 are further splited/seperated into more light beams in a larger number by the first grating 7, forming a lot of static light spots on a projecting plane existed between the first grating 7 and the light baffle 6. The lot of light spots also construct a static figure/imagery.

The light baffle 6 is moveably set close to the front cover 11. In the embodiment, the light baffle 6 is rotatably driven by the motor 10 via the gear box 9. The gear box 9 is fixed to the square frame 131 on the mounting board 13 and is set between the laser heads 51, 52 and the second grating 8. A through hole 91 used for permitting the light beams from the laser heads 51, 52 to pass through is define in the gear box 9. The second grating 8 may fixed on a supporting tube-shaped part received in the through hole 91 of the gear box 9. The motor 10 is used for driving the gear box 9, and is set adjacent to the gear box 9.

The light baffle 6 defines a plurality of through holes, and the other part of the light baffle 6 is light-proof. In the embodiment, the light baffle 6 is a round panel and a density of its through holes is close to that of the light spots projected to the light baffle 6. When the light baffle 6 rotates, the light beams passed through the first grating 7 is blocked and unblocked alternatly, and the light spots radiated to an external of the cylindrical shell 1 and then projected on a projecting plane are looked like twinkling stars, therefore a twinkling function is realized. Furthermore, because not all the light spots are block and unblocked at the same time, the light spots are twinkling irregularly, just like firefly flashing or twinkling stars.

A mounting hole 331 is defined in the protruding part 33 of the outer radiator 3. The laser spot light further includes a direction adjusting piece 17 having a shaft 171 rotatably mounted in the mounting hole 331 of the protruding part 33 of the outer radiator3. Plural of teeth extend penpendicully from a side surface, substantially perpendicular with the plate 31, of the protruding part 33; or plural of concave pits are formed in the side surface, substantially perpendicular with the plate 31, of the protruding part 33; the teeth or concave pits are distributed in a circle, the mounting hole 331 is defined in the center of the circle. Accordingly, plural of teeth 172 extend from the direction adjusting piece 17. The outer radiator 3 is operably rotated around the shaft 171 relative to the direction adjusting piece 17 depending on the mounting hole 331, the shaft 171, the plural of teeth or concave of the protruding part 33, and the plural of teeth of the direction adjusting piece 17.

In the above embodiment, the inner radiator 2 is integrated as a one-piece, in another embodiment as shown in FIG. 3, a inner radiator 2′ is divided into two pieces: a first radiator 23 defines a socket used for receiving a first laser head 51, and a second radiator 24 defines a socket used for receiving a second laser head 52. The second radiator 24 is attached to the first radiator 23, such that the heat from the second radiator 24 can also be conducted to the outer radiator via the frist radiator 23.

In the embodiment, the a light emitting direction of the first laser head 51 is perpendicular to that of the second laser head 52. A light filter 18 is utilized to reflect light from the second laser head 52 towards a direction parallel with the light emitting direction of the first laser head 51. The mounting board 13′ further includes two square frames 134, 135 used for receiving the lower parts of the second radiator 34 and a supporting base of the light filter 18, respectively. The heating element 15 and the temperature sensor 16 are fixed to the first radiator 23.

In other embodiment, the laser spot light may include only one laser head or more than two laser heads mounted on the inner radiator for dissipating heat generated by the laser head(s).

In other embodiments, the light baffle 6 may be driven to translate in relative to the first grating 7. For example, the light baffle 8 moves right and left or up and down in relative to the first grating 7, and a similar twinkling function can be realized.

In the embodiment, the through holes are distributed in the light baffle 6 uniformly. In the other embodiment, the through holes can be non-uniform distribution. In other embodiment, the light baffle 6 may be semicircular or has a large cut-out and can only block a part of the light beams at a time, thus can realize a rotation twinkling stars function.

To sum up, at least a part of heat generated by the at least one laser head can be transmitted to the outer radiator via the inner radiator, thus a heat dissipating effect is good, and when an ambient temperature is too low, the heating element can heat the laser head(s), therefore the operation temperature of the laser head(s) can be maitained with a normal range. Furthermore, the laser spot light of the invention utilize a motor driving a light baffle to rotate or translate, such that the static light spots generated by the first grating are blocked and unblocked alternatly, resulting a lot of twinkling light spots. Because not all the light beams are blocked and unblocked at the same time, the light spots are twinkling irregularly, can not cause visual fatigue.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A laser spot light with improved radiating structure, comprising:
a cylindrical shell defining a first through hole in its side wall;
a mounting board fixed within the cylindrical shell and defining a second through hole thereof;
at least one laser head;
an inner radiator made from heat-conductive metal and configured for supporting the at least one laser head and fixed on the mounting board; and
an outer radiator made from heat-conductive metal and fixed to the side wall of the cylindrical shell with a part of the outer radiator passing through the first through hole and the second through hole and touching with the inner radiator;
wherein at least a part of heat generated by the at least one laser head is transmitted to the outer radiator via the inner radiator.

2. The laser spot light of claim 1, wherein a layer of heat-conducting adhesive is set between the inner radiator and the outer radiator.

3. The laser spot light of claim 2, further comprising a heating element attached to the inner radiator.

4. The laser spot light of claim 2, wherein the outer radiator comprises a plate mounted to the side wall of the cylindrical shell, a post extending perpendicully from an inner side of the plate and passing through the first through hole and then the second through hole to touch with the inner radiator via the layer of the heat-conducting adhesive, and a protruding part extending perpendicully from an outer side of the plate.

5. The laser spot light of claim 4, wherein a mounting hole is defined in the protruding part of the outer radiator.

6. The laser spot light of claim 5, further comprising a direction adjusting piece having a shaft rotatably mounted in the mounting hole of the protruding part of the outer radiator, the outer radiator is operably rotated around the shaft relative to the direction adjusting piece.

7. The laser spot light of claim 6, wherein the cylindrical shell defines a first opening and a second opening at its two oposite ends, the laser spot light further comprises:
a light baffle moveably configured between the first opening and the at least one laser head;
a first grating has a star pattern configured between the light baffle and the at least one laser head;
a second grating has a pattern of figures configured between the first grating and the at least one laser head;
a motor;
a gearbox driven by the motor and configured to drive the light baffle to rotate or translating in relative to the first grating;
wherein the light baffle defines a plurality of through holes permitting light beams to pass through.

8. The laser spot light of claim 7, wherein the through holes are distributed in the light baffle uniformly.

9. The laser spot light of claim 7, wherein the gear box is configured between second grating and the at least one laser head, a through hole is defined in the gear box and is configured for permitting light beams emitted from the at least one laser head to pass through and reach the second grating.

10. The laser spot light of claim 9, wherein the light baffle is configured adjacent to the first opening.

11. The laser spot light of claim 10, wherein the inner radiator defines at least one socket configured for receiving the at least one laser head and configured for dissipating heat generated by the at least one laser head.

12. The laser spot light of claim 10, wherein the inner radiator compirses a first radiator defines a socket configured for receiving a first laser head, and a second radiator defines a socket configured for receiving a second laser head; the second radiator is attached to the first radiator.
